(19) United States
(12) Patent Application Publication
(10) Pub. No.: US 2025/0304007 A1
(43) Pub. Date: Oct. 2, 2025

(54) HANDS-FREE DEVICE FOR ACCESSING A VEHICLE IN THE NEAR-FIELD

(71) Applicant: Continental Automotive Technologies GmbH, Hannover (DE)

(72) Inventors: Guilherme Germano BUCHMEIER, TOULOUSE (FR); Amaia FORTES MONTILLA, MURET (FR); Mohamed CHEIKH, Toulouse (FR)

(73) Assignee: Continental Automotive Technologies GmbH, Hannover (DE)

(21) Appl. No.: 19/063,958

(22) Filed: Feb. 26, 2025

(30) Foreign Application Priority Data
Mar. 26, 2024 (FR) FR2403008

(51) Int. Cl. B60R 25/24; B60R 25/40; G07C 9/00; G07C 9/20

(52) U.S. Cl. CPC B60R 25/245; B60R 25/406; G07C 9/00309; G07C 9/20; B60R 2325/103; G07C 2009/00587; G07C 2009/00793

(57) ABSTRACT

A portable device for hands-free access to a motor vehicle. The device includes a radiofrequency transceiver and a radiofrequency antenna. The radiofrequency antenna is modified by connecting between the two ends of the radiofrequency antenna: a) a resonant circuit at a near-field communication frequency in series with b) a radiofrequency open circuit, c) a near-field communication antenna, electromagnetically coupled to the modified radiofrequency antenna, d) a device for managing the near-field communication, connected to the near-field communication antenna, e) a rechargeable battery, and f) a device for recharging the battery in near-field communication, which is connected to the near-field communication antenna.

### CROSS REFERENCE TO RELATED APPLICATION

This application claims priority to French Patent Application No. 2403008, filed Mar. 26, 2024, the contents of such application is incorporated by reference herein.

### FIELD OF THE INVENTION

The invention relates to a device for hands-free access to a vehicle in what is called near-field communication, for activating a vehicle function, of the “hands-free” access type to a motor vehicle.

### BACKGROUND OF THE INVENTION

In a motor vehicle, it is known practice to use vehicle function activation devices that can detect the presence of a hand or of a foot of a user of the vehicle and thus allow all or some of the opening elements of the vehicle, for example, the doors or the trunk, to be locked or unlocked. By way of example, detecting the presence of a hand of a user on or in front of a door handle, combined with the recognition of an identifier of a “hands-free” authentication device carried by this user, allows these opening elements to be locked and unlocked.

A “hands-free” access system for accessing a motor vehicle allows an authorized user to lock and/or unlock the opening elements of their vehicle without having to physically press buttons on a key. To this end, the vehicle proceeds to identify a hands-free access device such as a portable piece of equipment of the fob or remote control type or even a key, carried by the user, and if the fob or the remote control or even the key is located in a predetermined zone around the vehicle or in the vehicle and is identified as belonging to the vehicle, then the vehicle automatically locks/unlocks its opening elements depending on the intention of the user, without the user having to physically manipulate a key.

To achieve this, when the user approaches the vehicle, communication is established over a wireless communication link between the hands-free access device, for example an electronic fob or a smartphone, and the vehicle function activation device in order to authenticate said authentication device by virtue of its identifier.

To this end, the activation device comprises at least one radiofrequency antenna which makes it possible to receive the identifier sent by the hands-free access device. The activation device is connected to an electronic control unit (ECU) of the vehicle, to which it transmits the identifier.

In the prior art, the hands-free access device is generally an electronic fob. The signal received by the antenna of the activation device, comprising the identifier of the hands-free access device, is transmitted via radiofrequency (RF) or low frequency (LF) waves. The exact location of the hands-free access device around the vehicle is determined by measuring the strength of the RF signal received by said device (via the antennas and the electronic control unit) from the vehicle, which strength measurements are more commonly called RSSI measurements (RSSI standing for Received Signal Strength Indicator). The measurement of the power of each signal received by the hands-free access device from each antenna of the plurality of RF (“radiofrequency”) or LF (“low frequency”) antennas located on the vehicle V is received and analyzed by an activation device on board the vehicle, which thus determines, via triangulation, the position of said device with respect to said RF antennas, i.e., with respect to the vehicle.

Depending on the location of the hands-free access device identified by the vehicle, in said location zones some actions specific to said location zones are automatically carried out, such as unlocking/locking or preliminary switching-on of the passenger compartment lighting (also called “welcome lighting”).

Nowadays however, these hands-free access methods are susceptible to what are called “relay attacks” during which a thief will intercept the LF/RF signal exchange between the vehicle and the hands-free access device in order to deceive the vehicle and unlock it and then start it.

One solution to this problem is to make the authentication procedure even more secure by using for example near-field communication (NFC) which requires a proximity of a few centimeters between the hands-free access device and an NFC reader located on the vehicle. This proximity required during the authentication phase makes a relay attack more difficult.

However, the constrained space in a hands-free access fob makes the integration of an NFC antenna in addition to the electronic circuit and the radiofrequency antenna difficult; either the NFC antenna surrounds the electronic circuit and reduces the space allocated to the latter, or the NFC antenna is of smaller size located on one side of the fob, and in this case the NFC communication performance is degraded.

Another drawback of existing hands-free access devices is that they operate either on a cell for a fob or on a rechargeable battery for a mobile telephone; it may be that the cell is empty or the telephone is not charged thus making authentication impossible.

An aspect of the invention proposes a hands-free access device mitigating the drawbacks of the prior art, that is to say being robust against relay attacks, making it possible to ensure authentication even in the case where the cell of the fob or the telephone is not charged, ensuring a satisfactory NFC communication range and being easily able to be integrated into a hands-free access device.

### SUMMARY OF THE INVENTION

An aspect of the invention relates to a portable device for hands-free access to a motor vehicle, said device comprising radiofrequency transceiver means and a radiofrequency antenna, characterized in that the radiofrequency antenna is modified by connecting between the two ends of said radiofrequency antenna:
a. a resonant circuit at a near-field communication frequency, in series with
b. a radiofrequency open circuit,
c. a near-field communication antenna electromagnetically coupled to the modified radiofrequency antenna,
d. means for managing the near-field communication, connected to the near-field communication antenna,
e. a rechargeable battery,
f. means for recharging the battery in near-field communication, which means are connected to the near-field communication antenna.

Preferably, the resonant circuit comprises at least one resonant capacitor in near-field communication.

Furthermore, the radiofrequency open circuit comprises at least one inductor and at least one capacitor.

Advantageously, the radiofrequency antenna is located at one end of the device.

An aspect of the invention also applies to any motor vehicle equipped with a hands-free access device according to any one of the features set out above.

### BRIEF DESCRIPTION OF THE DRAWINGS

Other features and advantages of aspects of the invention will become more apparent on reading the following description. This description is purely illustrative and should be read with reference to the attached drawings, in which:

FIG. 1 is a schematic representation of a motor vehicle and of a portable hands-free access device according to an aspect of the invention,

FIG. 2 is a schematic representation of the portable hands-free access device according to an aspect of the invention,

FIG. 3 is a graph illustrating, along a longitudinal axis of the portable hands-free access device, the field of communication in near-field communication according to the prior art (continuous line) and according to an aspect of the invention (dashed line).

### DETAILED DESCRIPTION OF EXEMPLARY EMBODIMENTS

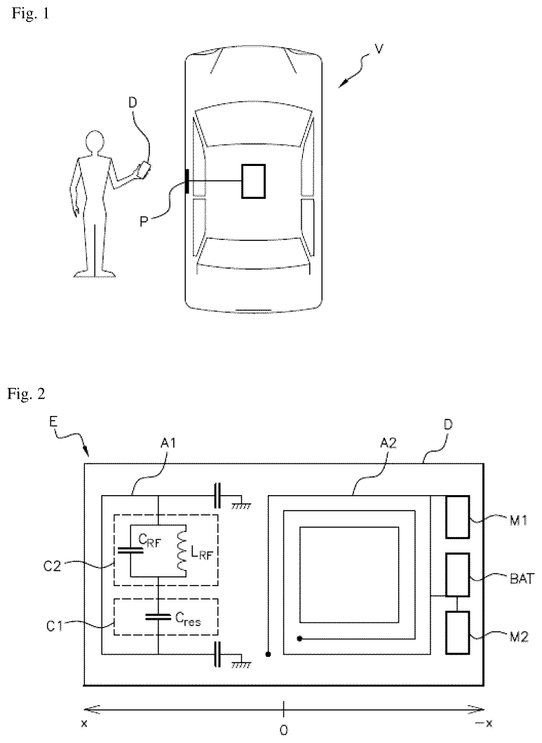

FIG. 1 shows a motor vehicle V and a portable device D for hands-free access to said vehicle. The portable device D is equipped with a radiofrequency antenna A1 in order to communicate with said vehicle V. Said device D also comprises a rechargeable battery.

Accessing a motor vehicle V by way of a hands-free access device is known from the prior art and will not be described in more detail here.

An aspect of the invention proposes for the portable hands-free access device to comprise near-field communication means, that is to say NFC means, at 13.56 MHz, able to be easily integrated into the device, requiring little space and making it possible, inter alia, to prevent relay attacks but above all making it possible to recharge the battery of the portable device.

For this purpose, according to an aspect of the invention, the portable hands-free access device D is modified such that the following are connected between the two ends of said radiofrequency antenna A1:
a. a resonant circuit C1 at a near-field communication frequency, in series with
b. a radiofrequency open circuit C2, also called a stripline circuit,
c. a near-field communication antenna A2, electromagnetically coupled to the modified radiofrequency antenna A1,
d. means M1 for managing the near-field communication,
e. a rechargeable battery BAT,
f. means M2 for recharging the battery in near-field communication.

Preferably, the resonant circuit C1 comprises at least one resonant capacitor Cres in near-field communication.

The radiofrequency open circuit C2 for its part comprises at least one inductor L_{RF} and at least one capacitor C_{RF} which are connected in parallel.

The addition of these components to the existing radiofrequency antenna A1 modifies the functions of said antenna A1.

The latter remains a radiofrequency communication antenna at radiofrequency communication frequencies but it also allows near-field communication at near-field communication frequencies.

The near-field-communication antenna A2 comprised in the device D is electromagnetically coupled to said radiofrequency antenna A1 modified in this way.

The device D then comprises two near-field communication antennas A1, A2, a modified antenna A1 able to communicate in near field, and a near-field communication antenna A2, electromagnetically coupled to the modified antenna A1.

The advantage of such a device D is the near-field communication NFC range which is extended compared to the prior art, that is to say compared to a portable device equipped solely with a near-field communication antenna.

Preferably, the radiofrequency communication antenna A1 is located at one end (E) of the portable device D.

Thus, the modified radiofrequency antenna A1 according to an aspect of the invention is able to communicate in near field with a near-field communication NFC reader located on the vehicle V, for example in the door handle P of said vehicle V.

This is illustrated in FIG. 2.

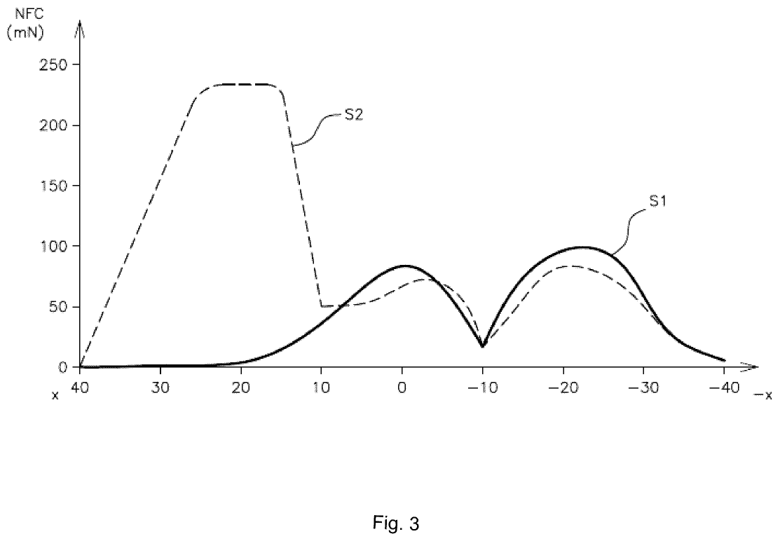

The antenna A1 modified in this way has an extended near-field communication range. This is illustrated in—FIG. 3.

FIG. 3 shows, along a longitudinal axis (x, −x) along the portable access device D (cf. FIG. 2), the range of the near-field communication NFC field in mW:
a. according to the prior art, on curve S1, that is to say with a single near-field communication antenna and
b. according to an aspect of the invention, on curve S2, that is to say with a radiofrequency antenna A1 modified so as to be able to communicate in near field.

It is clearly apparent that the range of the communication field is extended at the end of the portable device D, where the modified radiofrequency antenna A1 is located (between x=40 and x=15). The field, which does not exist at this location with the device of the prior art, reaches high values (250 mW) with the portable device according to an aspect of the invention. The ranges of two fields remain approximately identical along the longitudinal axis for values of x lower than 15.

It is evident that this increase in field power allows easier and more effective near-field communication between the portable access device and the NFC reader of the vehicle.

The radiofrequency antenna A1 modified in this way not only allows more robust communication but also allows the rechargeable battery of the device D to be recharged more quickly by way of the electromagnetic coupling between said modified radiofrequency antenna A1 and the NFC antenna A2 itself connected to the rechargeable battery BAT.

The invention therefore makes it possible to mitigate the drawbacks of the prior art in an ingenious way, that is to say not only to increase the near-field communication range of the portable access device (D) but also to recharge the rechargeable battery of the device by NFC.

1. A portable device for hands-free access to a motor vehicle, said device comprising a radiofrequency transceiver and a radiofrequency antenna, wherein the radiofrequency antenna is modified by connecting between the two ends of said radiofrequency antenna a resonant circuit at a near-field communication frequency in series with a radiofrequency open circuit, the device comprising:
a) a near-field communication antenna, electromagnetically coupled to the modified radiofrequency antenna,
b) means for managing the near-field communication, connected to the near-field communication antenna,
c) a rechargeable battery,
d) means for recharging the battery in near-field communication, which means are connected to the near-field communication antenna,
said modified antenna being a radiofrequency communication antenna at radiofrequency communication frequencies and allowing near-field communication at near-field communication frequencies.

2. The portable device for hands-free access to a motor vehicle as claimed in claim 1, wherein the resonant circuit comprises at least one resonant capacitor in near-field communication.

3. The portable device for hands-free access to a motor vehicle as claimed in claim 1, wherein the radiofrequency open circuit comprises at least one inductor and at least one capacitor.

4. The portable device for hands-free access to a motor vehicle as claimed in claim 1, wherein the radiofrequency antenna is located at one end of the device.

5. A motor vehicle, characterized in that it is equipped with a hands-free access device as claimed in claim 1.
